(19) United States
(12) Patent Application Publication
(10) Pub. No.: US 2008/0119355 A1
(43) Pub. Date: May 22, 2008

(54) METHOD FOR MANUFACTURING HONEYCOMB STRUCTURE

(75) Inventors: Kazushige Ohno, Ibi-gun (JP); Takahiko Ido, Ibi-gun (JP); Chizuru Kasai, Ibi-gun (JP)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/939,467

(22) Filed: Nov. 13, 2007

(30) Foreign Application Priority Data
Nov. 16, 2006 (JP) PCT/JP2006/032287
Dec. 14, 2006 (JP) PCT/JP2006/324983

(51) Int. Cl. B01J 21/04

(52) U.S. Cl. 502/340; 502/439; 264/630; 502/100; 156/89.22; 427/207.1; 502/344

(57) ABSTRACT

A method for manufacturing a honeycomb structure includes mixing inorganic particles, at least one of inorganic fibers and inorganic whiskers, and an inorganic binder solution to prepare a raw material composition. The method further includes manufacturing a pillar-shaped honeycomb molded body by extrusion-molding the raw material composition, and firing the molded body to manufacture a honeycomb fired body. The molded body has a large number of cells disposed in substantially parallel with one another in a longitudinal direction with a cell wall therebetween. A blending amount of the inorganic binder solution is about 30 to about 60% by weight to the total amount of the inorganic particles, at least one of the inorganic fibers and the inorganic whiskers, and the inorganic binder solution. A concentration of the inorganic binder solution is about 35 to about 50% by weight.

### CROSS-REFERENCE TO RELATED APPLICATIONS

The present application claims priority under 35 U.S.C. §119 to PCT Application Nos. PCT/JP2006/322878, filed Nov. 16, 2006 and PCT/JP2006/324983, filed Dec. 14, 2006. The contents of these PCT applications are incorporated herein by reference in their entirety.

### BACKGROUND OF THE INVENTION

1. Field of the Invention

The present invention relates to a method for manufacturing a honeycomb structure.

2. Discussion of the Background

Conventionally, honeycomb catalysts formed by supporting catalyst components on a honeycomb structure, which are used for converting exhaust gases of vehicles, are being manufactured by supporting materials having a large specific surface area such as activated alumina and a catalyst metal such as platinum on the surface of a cordierite-based honeycomb structure having an integral structure and low thermal expansion. In addition, an alkaline earth metal such as barium (Ba) is supported on the honeycomb catalyst of this kind as a NOx adsorber in order to treat NOx in an atmosphere of excess oxygen like those in a lean burn engine and a diesel engine. Here, the more improvements in the performance of converting the exhaust gases require that the probability of contact of the exhaust gases with a catalyst noble metal and the NOx adsorber is increased. In order to do so, it is necessary that a carrier has a larger specific surface area, that a particle diameter of the noble metal is reduced, and that the noble metal particles are highly dispersed. And so, as a honeycomb structure containing a material having a large specific surface area, for example, honeycomb structures formed by extrusion-molding inorganic particles and inorganic fibers with an inorganic binder are known (for example, see Japanese Unexamined Patent Application Publication Nos. 2005-218935 A, 2005-349378 A, and 05-213681 A). The contents of Japanese Unexamined Patent Application Publication Nos. 2005-218935 A, 2005-349378 A, and 05-213681 A are incorporated herein by reference in their entirety.

### SUMMARY OF THE INVENTION

A method for manufacturing a honeycomb structure of the present invention includes mixing inorganic particles, at least one of inorganic fibers and inorganic whiskers, and an inorganic binder solution to prepare a raw material composition. The method further includes manufacturing a pillar-shaped honeycomb molded body by extrusion-molding the raw material composition and carrying out a firing treatment on the honeycomb molded body to manufacture a honeycomb fired body. The pillar-shaped honeycomb molded body has a large number of cells disposed in substantially parallel with one another in a longitudinal direction with a cell wall therebetween. A blending amount of the inorganic binder solution is about 30 to about 60% by weight to the total amount of the inorganic particles, at least one of inorganic fibers and inorganic whiskers, and the inorganic binder solution. A concentration of the inorganic binder solution is about 35 to about 50% by weight.

In the method for manufacturing a honeycomb structure of the present invention, the inorganic binder solution is desirably at least one kind selected from the group consisting of alumina sol, silica sol, titania sol, a suspension of sepiolite and a suspension of attapulgite.

An average particle diameter of an inorganic binder in the inorganic binder solution is preferably about 10 nm to about 50 nm.

The inorganic particles preferably include at least one of alumina, silica, zirconia, titania, ceria, mullite, and zeolite.

A blending amount of the inorganic particles in the raw material composition is preferably about 30% to about 85% by weight with respect to a total solid content of the inorganic particles, at least one of the inorganic fibers and the inorganic whiskers, and the inorganic binder.

At least one of the inorganic fibers and the inorganic whiskers preferably include at least one of alumina, silica, silicon carbide, silica-alumina, glass, potassium titanate, and aluminum borate.

An average aspect ratio of at least one of the inorganic fibers and the inorganic whiskers is preferably about 10 to about 1000.

A blending amount of at least one of the inorganic fibers and the inorganic whiskers in the raw material composition is preferably about 3% to about 50% by weight with respect to a total solid content of the inorganic particles, at least one of the inorganic fibers and the inorganic whiskers, and the inorganic binder.

A firing temperature in the firing treatment is preferably about 500° C. to about 1200° C.

The method for manufacturing a honeycomb structure preferably further includes providing a coat layer on the periphery of the honeycomb fired body.

The honeycomb structure is preferably formed of a single honeycomb fired body.

The method for manufacturing a honeycomb structure preferably further includes binding a plurality of the honeycomb fired bodies together to form the honeycomb structure.

A cross-sectional area of the honeycomb fired body in a direction perpendicular to a longitudinal direction of the honeycomb fired body is preferably about 5 cm² to about 50 cm².

The method for manufacturing a honeycomb structure preferably further includes providing at least one of an adhesive layer and a coat layer on the honeycomb fired body. A ratio of a cross-sectional area of the honeycomb fired body in a plane perpendicular to a longitudinal direction of the honeycomb structure with respect to a cross-sectional area of the honeycomb structure including at least one of the adhesive layer and the coat layer is at least about 90%.

A specific surface area per unit area of the honeycomb structure is preferably about 25000 m²/L to about 70000 m²/L.

The method for manufacturing a honeycomb structure preferably further includes supporting a catalyst on the honeycomb fired body.

The catalyst preferably includes at least one of noble metals, alkali metals, alkaline earth metals, and oxides.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1(a) is a perspective view schematically showing one example of a honeycomb fired body manufactured by the method for manufacturing a honeycomb structure according to an embodiment of the present invention, and FIG. 1(b) is a perspective view schematically showing one example of a honeycomb structure of the present invention formed by using the honeycomb fired body shown in FIG. 1(a).

FIG. 2 is a perspective view schematically showing another example of the honeycomb structure manufactured by the method for manufacturing a honeycomb structure according to the embodiment of the present invention.

### DESCRIPTION OF THE EMBODIMENTS

The embodiments will now be described with reference to the accompanying drawings, wherein like reference numerals designate corresponding or identical elements throughout the various drawings.

Hereinafter, the method for manufacturing a honeycomb structure according to the embodiment of the present invention will be described in detail.

The method for manufacturing a honeycomb structure according to the embodiment of the present invention is includes a preparing step of mixing: inorganic particles; at least one of inorganic fibers and inorganic whiskers; and an inorganic binder solution, to prepare a raw material composition; a molding step of manufacturing a pillar-shaped honeycomb molded body having a large number of cells disposed in substantially parallel with one another in a longitudinal direction with a cell wall therebetween by extrusion-molding the raw material composition; and a firing step of carrying out a firing treatment on the honeycomb molded body to manufacture a honeycomb fired body, wherein a blending amount of the inorganic binder solution is about 30 to about 60% by weight to the total amount of the inorganic particles, at least one of the inorganic fibers and the inorganic whiskers, and an inorganic binder solution, and a concentration of the inorganic binder solution is about 35 to about 50% by weight.

Further, in the present invention, the concentration of the inorganic binder refers to a weight percentage of an inorganic binder content to the total weight of an inorganic binder solution.

Here, in the present specification, a pillar shape includes arbitrary pillar shapes such as a round pillar shape, a cylindroid shape, and a polygonal pillar shape.

Conventionally, when a honeycomb structure is manufactured by undergoing a step of extrusion-molding inorganic particles and inorganic fibers with an inorganic binder, cracks or deformations may be generated in a molded body or a fired body upon carrying out a heating treatment (drying treatment, degreasing treatment, firing treatment and the like) on the extrusion-molded body.

The generation of cracks or deformations results from the composition of a raw material composition to be extrusion-molded, that is, when an amount of a solid matter is small in an inorganic binder solution used upon preparing a raw material composition, an amount of a solvent such as water is relatively large, and therefore an amount of a solvent contained in the raw material composition such as water becomes large, and consequently if carrying out an extrusion-molding step and a subsequent heating treatment such as drying treatment on such raw material composition, shrinkage of the molded body becomes large, and cracks or deformations described above are likely to be generated.

Furthermore, for preventing the generation of cracks and deformations described above, it is effective to adjust a concentration of an inorganic binder contained in the inorganic binder solution in a prescribed range.

In the method for manufacturing a honeycomb structure according to the embodiment of the present invention, it becomes easy to prevent causing deformations and cracks in a honeycomb molded body and a honeycomb fired body in a manufacturing step of the honeycomb structure since an inorganic binder solution having a prescribed concentration is mixed in a raw material composition with a prescribed amount.

Hereinafter, the method for manufacturing a honeycomb structure according to the embodiment of the present invention will be described step by step.

(1) In the method for manufacturing a honeycomb structure of the present invention, first, a preparing step is carried out to prepare a raw material composition including inorganic particles; at least one of inorganic fibers and inorganic whiskers; and an inorganic binder solution.

As the raw material composition, as needed, a substance further containing an organic binder, a dispersion medium and a forming auxiliary, which are appropriately added according to the moldability of the raw material composition, can be used.

In the method for manufacturing a honeycomb structure according to the embodiment of the present invention, as the inorganic binder solution, an inorganic binder solution having a lower limit of concentration of about 35% by weight and an upper limit of about 50% by weight is used.

By using the raw material composition containing such an inorganic binder solution to manufacture the honeycomb structure, cracks and deformations are not likely to be generated in the honeycomb molded body and the honeycomb fired body during a manufacturing step.

On the other hand, when the concentration of the inorganic binder solution is less than about 35% by weight, since an amount of a solvent such as water contained in the raw material composition is large, cracks or deformations are likely to be generated in the honeycomb molded body or the honeycomb fired body during a manufacturing step of the honeycomb structure though the good moldability can be secured upon extrusion-molding the raw material composition. In addition, when the concentration of the inorganic binder solution is more than about 50% by weight, the moldability tends to be poor upon extrusion-molding the raw material composition, and therefore it may become difficult to manufacture a molded body having a desired configuration.

Here, the inorganic binder solution has a further desirable upper limit of concentration of about 45% by weight.

As the inorganic binder solution, inorganic sols and suspensions of a clay binder can be used, and the specific examples of the inorganic sols include alumina sol, silica sol, titania sol, and the like. Specific examples of the clay binders include clays having a multiple-chain structure such as white clay, kaolin, montmorillonite, sepiolite, attapulgite, and the like. These inorganic binder solutions may be used alone or in combination of two or more kinds.

Among these, at least one kind selected from the group consisting of alumina sol, silica sol, titania sol, the suspension of sepiolite and the suspension of attapulgite is desirable.

Desirably, an average particle diameter of the inorganic binder contained in the inorganic binder solution has a lower limit of about 10 nm and an upper limit of about 50 nm. The reason for this is that a honeycomb structure having a large specific surface area and high strength may easily be manufactured by undergoing the manufacturing steps described later.

When an average particle diameter of the inorganic binder is about 10 nm or more and about 50 nm or less, the strength of the manufactured honeycomb structure does not tend to become insufficient. The reason for this is presumably described as follows.

That is, in the method for manufacturing a honeycomb structure according to the embodiment of the present invention, presumably, the inorganic binder mainly plays a role of bonding the inorganic particles, the inorganic fibers and the inorganic whiskers, and the inorganic binder presumably exerts an adhesive function by interposing between the inorganic fibers (inorganic whiskers) and the inorganic particles to simultaneously come into contact with the inorganic fibers (inorganic whiskers) and the inorganic particles, or by interposing between each of the inorganic particles to simultaneously come into contact with the different inorganic particles.

Here, presumably, when the average particle diameter is about 10 nm or more, it becomes easy to simultaneously come into contact with the inorganic fibers (inorganic whiskers) and the inorganic particles and to simultaneously come into contact with the different inorganic particles, and therefore there are cases where a sufficient adhesive strength may easily be obtained, and on the other hand, when the average particle diameter is about 50 nm or less, the number of points to be bonded increases and consequently the strength does not tend to become insufficient.

Furthermore, when an average particle diameter of the inorganic binder is about 50 nm or less, the specific surface area of the manufactured honeycomb structure tends to increase sufficiently, and it is advantageous when the honeycomb structure is used as a catalyst supporting carrier.

In addition, a more desired average particle diameter of the inorganic binder is about 20 nm in the lower limit and about 40 nm in the upper limit.

In addition, the average particle diameter of the inorganic binder can be measured, for example, by the following method.

Specifically, when the inorganic binder is silica sol, first, the silica sol is dried, and BET specific surface area thereof is measured.

Next, assumed that silica particles in the silica sol are dense spherical particles, the BET specific surface area is determined from the following equation (1):

BET specific surface area=(6000/ρ)/particle diameter (1)

(in the equation, ρ is a true density (2.2 g/cm³) of silica)

Further, the average particle diameter of the inorganic binder can be also directly measured by using, for example, TEM (transmission electron microscope).

In addition, in the method for manufacturing a honeycomb structure, a blending amount of the inorganic binder solution has a lower limit of about 30% by weight and an upper limit of about 60% by weight to the total amount of the inorganic particles, at least one of the inorganic fibers and the inorganic whiskers, and the inorganic binder solution.

The reason for this is that when the blending amount of the inorganic binder solution is about 30% by weight or more, the strength of the manufactured honeycomb structure does not tend to be deteriorated since an amount of the inorganic binder contained in the honeycomb structure is increased, and on the other hand, when the blending amount of the inorganic binder solution is about 60% by weight or less, the moldability of the raw material composition does not tend to be deteriorated.

A blending amount of the inorganic binder solution has a further desirable upper limit of about 50% by weight to the total amount of: the inorganic particles, at least one of the inorganic fibers and inorganic whiskers, and the inorganic binder solution.

Examples of the inorganic particles include particles of alumina, silica, zirconia, titania, ceria, mullite, zeolite and the like. These particles may be used alone or in combination of two or more kinds.

Among these particles, alumina particles and ceria particles are particularly desirable.

A blending amount of the inorganic particles has a desirable lower limit of about 30% by weight, a more desirable lower limit of about 40% by weight, and a furthermore desirable lower limit of about 50% by weight to the total amount of the inorganic particles, at least one of the inorganic fibers and the inorganic whiskers, and the solid matter of the inorganic binder solution (hereinafter, referred to as the total amount of essential raw materials).

On the other hand, the blending amount of the inorganic particles is about 85% by weight as a desirable upper limit, about 80% by weight as a more desirable upper limit, and about 75% by weight as a furthermore desirable upper limit.

When the blending amount of the inorganic particles is about 30% by weight or more, the specific surface area of the manufactured honeycomb structure does not tend to be reduced since the amount of the inorganic particles contributing to the increase of specific surface area is relatively increased, and therefore it may become easier to highly disperse a catalyst component upon supporting the catalyst component on a catalyst supporting carrier. On the other hand, when the blending amount of the inorganic particles is about 85% by weight or less, the strength of the manufactured honeycomb structure does not tend to be deteriorated since the amounts of the inorganic binder, the inorganic fibers and the inorganic whiskers, contributing to the improvement of the strength, are relatively increased.

In addition, secondary particles of the inorganic particles mixed in the raw material composition desirably have an average particle diameter of about 0.5 to about 20 μm.

When the average particle diameter of secondary particles is about 0.5 μm or more, the manufactured honeycomb structure does not tend to be densified, and therefore the permeability of gases does not tend to be low upon using the honeycomb structure as a catalyst supporting carrier, and on the other hand, when the average particle diameter of secondary particles is about 20 μm or less, the specific surface area of the manufactured honeycomb structure does not tend to be reduced.

Incidentally, primary particles of the inorganic particles desirably have an average particle diameter of about 5 to about 100 nm.

In the present specification, the primary particles refer to particles forming a powder or agglomerate, and also refer to particles of a minimum unit existing without breaking a bond between molecules. In addition, the secondary particles refer to particles formed by the agglomeration of the primary particles.

In addition, the inorganic particles (secondary particles) desirably have a specific surface area of about 50 to about 300 m²/g.

The reason for this is that when the specific surface area is about 50 m²/g or more, the specific surface area of the manufactured honeycomb structure does not tend to be reduced, and on the other hand, when the specific surface area is more than about 300 m²/g, the specific surface area of the honeycomb structure is not increased so much even though the specific surface area of the inorganic particles (secondary particles) is increased. Thus, about 300 m²/g or less of the specific surface area is preferred.

In addition, in the method for manufacturing a honeycomb structure according to the embodiment of the present invention, the inorganic particles (secondary particles) desirably have an average aspect ratio of about 1 to about 5.

Examples of the inorganic fibers or inorganic whiskers include inorganic fibers and inorganic whiskers containing alumina, silica, silicon carbide, silica-alumina, glass, potassium titanate, aluminum borate, or the like.

These inorganic fibers or inorganic whiskers may be used alone or in combination of two or more kinds.

In addition, in the method for manufacturing a honeycomb structure according to the embodiment of the present invention, the inorganic fibers or the inorganic whiskers have an average aspect ratio of more than 5.

Further, an average aspect ratio of each of the inorganic fibers and inorganic whiskers is desirably about 10 to about 1000.

The total blending amount of at least one of the inorganic fibers and inorganic whiskers is about 3% by weight as a desirable lower limit to the total amount of essential raw materials, about 5% by weight as a more desirable lower limit, and about 8% by weight as a furthermore desirable lower limit. On the other hand, the blending amount of at least one of the inorganic fibers and inorganic whiskers is about 50% by weight as a desirable upper limit, about 40% by weight as a more desirable upper limit, and about 30% by weight as a furthermore desirable upper limit.

When the total blending amount of at least one of the inorganic fibers and inorganic whiskers is about 3% by weight or more, the strength of the manufactured honeycomb structure does not tend to be deteriorated, and on the other hand, when this total blending amount is about 50% by weight or less, since the amount of the inorganic particles contributing to the increase of specific surface area is relatively increased in the manufactured honeycomb structure, when the manufactured honeycomb structure is used as a catalyst supporting carrier, the specific surface area of the honeycomb structure is increased, and therefore it becomes easier to highly disperse a catalyst component upon supporting the catalyst component on a catalyst supporting carrier.

In the raw material composition, an organic binder, a dispersion medium, and a forming auxiliary may be mixed.

The organic binder is not particularly limited, and examples of the binder include methyl cellulose, carboxymethyl cellulose, hydroxyethyl cellulose, polyethylene glycol, and the like.

These binders may be used alone or in combination of two or more kinds.

A blending amount of the organic binder is desirably about 1 to about 10 parts by weight to 100 parts by weight of the total solid matter of the inorganic particles, the inorganic fibers, the inorganic whiskers and the inorganic binder solution.

The forming auxiliary is not particularly limited, and examples of the forming auxiliary include ethylene glycol, dextrin, fatty acid, fatty acid soap, polyalcohol and the like.

Among these, oleic acid is desirably further mixed in order to further improve the moldability.

A method for preparing the raw material composition is not particularly limited, and it is preferred to mix and/or knead a raw material, and the raw material may be mixed with, for example, a mixer or an attritor, or may be kneaded well with a kneader.

(2) Next, a molding step is carried out to manufacture a pillar-shaped honeycomb molded body having a large number of cells disposed in substantially parallel with one another in a longitudinal direction with a cell wall therebetween by extrusion-molding the raw material composition.

(3) A drying step is carried out as needed on the honeycomb molded body.

The drying step can be carried out with, for example, a microwave drying apparatus, a hot-air drying apparatus, a dielectric drying apparatus, a reduced pressure drying apparatus, a vacuum drying apparatus, a freeze drying apparatus, and the like.

(4) A degreasing step is carried out, as needed, on the honeycomb molded body dried as needed.

In this case, degreasing conditions are not particularly limited and appropriately selected according to kinds and amounts of organic substances contained in the molded body, and about 400° C. and about 2 hours are desirable as these conditions.

(5) Next, a firing step of carrying out a firing treatment on the honeycomb molded body dried and degreased as needed to manufacture a honeycomb fired body is carried out.

A firing temperature in the firing treatment is not particularly limited, and a temperature of about 500 to about 1200° C. is desirable, and a temperature of about 600 to about 1000° C. is more desirable.

When the firing temperature is about 500° C. or more, an adhesive function of the inorganic binder tends to develop and sintering of the inorganic particles also tends to proceed, and therefore the strength of the manufactured honeycomb structure dos not tend to be deteriorated, and when it is about 1200° C. or less, the sintering of the inorganic particles does not proceed too excessively and the specific surface area per unit volume of the manufactured honeycomb structure is increased, and therefore it becomes easier to sufficiently highly disperse a catalyst component to be supported on a honeycomb structure upon using the honeycomb structure as a catalyst supporting carrier.

By undergoing these steps, a pillar-shaped honeycomb fired body having a large number of cells disposed in substantially parallel with one another in a longitudinal direction with a cell wall therebetween can be manufactured.

The honeycomb fired body itself, manufactured by undergoing these steps, may be provided as a honeycomb structure according to one of the embodiments of the present invention, and in the method for manufacturing a honeycomb structure according to the embodiment of the present invention, the overall steps can be terminated at the firing step.

Further, a sealing material layer (coat layer) is formed on the periphery of the honeycomb fired body manufactured by the above-mentioned manufacturing method, and the resulting honeycomb fired body may be used as a finished product of the honeycomb structure. The honeycomb structure including one honeycomb fired body is also referred to as an integral honeycomb structure in the following.

Here, a method for forming the sealing material layer (coat layer) is similar to a method for forming a sealing material layer (coat layer) on the periphery of a honeycomb block upon manufacturing the honeycomb structure by binding a plurality of the honeycomb fired bodies together to form the honeycomb block to be described later.

Further, in the method for manufacturing a honeycomb structure according to the embodiment of the present invention, the honeycomb structure may be manufactured by the above-mentioned method, and then binding a plurality of these honeycomb fired bodies together to form the honeycomb block.

In this case, the following method may be used.

Hereinafter, the honeycomb structure formed by binding a plurality of the honeycomb fired bodies together is also referred to as an aggregated honeycomb structure.

That is, a sealing material paste to become a sealing material layer (adhesive layer) is applied to the obtained honeycomb fired body to bind the honeycomb fired body in sequence, and thereafter the sealing material paste is dried and solidified to manufacture an aggregate of the honeycomb fired bodies having a prescribed size bound by interposing the sealing material layer (adhesive layer).

In addition, a prescribed number of the honeycomb fired bodies are piled up by interposing a spacer, and then a sealing material paste is filled into a gap between the honeycomb fired bodies, and thereafter the sealing material paste is dried and solidified to manufacture an aggregate of the honeycomb fired bodies having a prescribed size bound by interposing the sealing material layer (adhesive layer).

The sealing material paste for forming an adhesive layer is not particularly limited, and for example, a mixture of an inorganic binder and ceramic particles, a mixture of an inorganic binder and inorganic fibers, or a mixture of an inorganic binder, ceramic particles and inorganic fibers can be used.

In addition, an organic binder may be added to these sealing material pastes.

The organic binder is not particularly limited, and examples of the binder include polyvinyl alcohol, methyl cellulose, ethyl cellulose, carboxymethyl cellulose and the like.

These binders may be used alone or in combination of two or more kinds.

A thickness of the sealing material layer (adhesive layer) is desirably about 0.5 to about 5 mm.

When the thickness of the sealing material layer (adhesive layer) is about 0.5 mm or more, sufficient adhesive strength may easily be obtained, and when the thickness of the sealing material layer (adhesive layer) is about 5 mm or less, since the sealing material layer (adhesive layer) is a portion not functioning as a catalyst supporting carrier, the specific surface area per unit volume of the honeycomb structure does not tend to be reduced, and therefore it becomes easier to sufficiently highly disperse a catalyst component upon supporting the catalyst component on a catalyst supporting carrier.

Further, when the thickness of the sealing material layer (adhesive layer) is about 5 mm or less, pressure loss does not tend to become high.

Here, the number of the honeycomb fired bodies to be bound may be appropriately determined according to the size of the honeycomb structure. An aggregate of the honeycomb fired bodies formed by binding the honeycomb fired bodies together by interposing the sealing material layer (adhesive layer) is appropriately cut and polished as needed to form a honeycomb block.

Next, a sealing material layer (coat layer) is formed by applying a sealing material paste for forming a coat layer onto the periphery of the honeycomb block as needed, and drying and solidifying the sealing material paste.

By forming the sealing material layer (coat layer), the periphery of the honeycomb block can be protected, and consequently the strength of the honeycomb structure may easily be improved.

The sealing material paste for forming the coat layer is not particularly limited, and it may be made from the same materials as of the sealing material paste for forming the adhesive layer, or may be made from the different materials from those of the sealing material paste for forming the adhesive layer.

In addition, when the sealing material paste for forming the coat layer is made from the same materials as of the sealing material paste for forming the adhesive layer, blending ratios of the composition of both the sealing material pastes may be the same as or different from each other.

A thickness of the sealing material layer (coat layer) is not particularly limited, and this thickness is desirably about 0.1 to about 2 mm. When the thickness is about 0.1 mm or more, the periphery can be protected fully and the strength tends to be improved, and when the thickness is about 2 mm or less, the specific surface area per unit volume of the honeycomb structure does not tend to be reduced, and therefore it becomes easier to sufficiently highly disperse a catalyst component upon supporting the catalyst component on a catalyst supporting carrier.

In addition, in the method for manufacturing a honeycomb structure of the present invention, it is preferred to calcine the honeycomb fired bodies after binding a plurality of the honeycomb fired bodies together by interposing the sealing material layer (adhesive layer) (however, when a sealing material layer (coat layer) is provided, calcine them after forming the coat layer).

The reason for this is that when an organic binder is contained in the sealing material layer (adhesive layer) and the sealing material layer (coat layer), the organic binder can be degreased and removed by calcination.

The conditions of the calcination are appropriately determined according to kinds and amounts of organic substances contained, and about 700° C. and about 2 hours are desirable as these conditions.

Next, the configuration of the honeycomb structure manufactured by the method for manufacturing a honeycomb structure according to the embodiment of the present invention will be described referring to drawings.

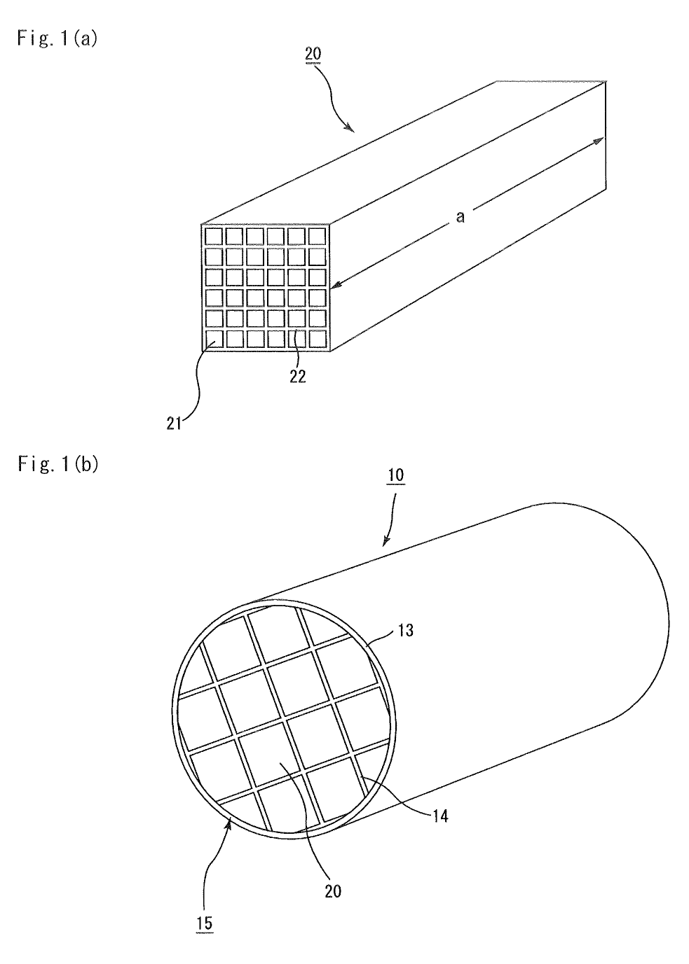

FIG. 1(a) is a perspective view schematically showing one example of a honeycomb fired body manufactured by the method for manufacturing a honeycomb structure according to the embodiment of the present invention, and FIG. 1(b) is a perspective view schematically showing one example of a honeycomb structure formed by using the honeycomb fired body shown in FIG. 1(a).

As shown in FIG. 1(a), a honeycomb fired body 20 has a square pillar shape, and has a large number of cells 21 disposed in substantially parallel with one another in a longitudinal direction (the direction shown by an arrow a in FIG. 1(a)) with a cell wall 22 therebetween.

As shown in FIG. 1(b), in a honeycomb structure 10, a plurality of the honeycomb fired bodies 20 shown in FIG. 1(a) are bound together by interposing a sealing material layer (adhesive layer) 14 to configure a ceramic block 15, and a sealing material layer (coat layer) 13 is formed on the periphery thereof.

In the honeycomb fired body, a thickness of the cell wall is not particularly limited, and the thickness of the cell wall has a desirable lower limit of about 0.05 mm, a more desirable lower limit of about 0.10 mm, and a particularly desirable lower limit of about 0.15 mm. On the other hand, the thickness of the cell wall has a desirable upper limit of about 0.35 mm, a more desirable upper limit of about 0.30 mm, and a particularly desirable upper limit of about 0.25 mm.

When the thickness of the cell wall is about 0.05 mm or more, the strength of the honeycomb fired body does not tend to be deteriorated, and on the other hand, when the thickness of the cell wall is about 0.35 mm or less, the performance of converting the exhaust gases does not tend to be deteriorated since a contacting area with the exhaust gases does not tend to be reduced, and the gases tend to permeate deeply into a catalyst supporting carrier and therefore the catalyst supported on the inner surface in the cell wall may easily comes into contact with the gases upon using the honeycomb structure as a catalyst supporting carrier for converting the exhaust gases.

In addition, a cell density of the honeycomb fired body has a desirable lower limit of about 15.5 pcs/cm² (about 100 cpsi), a more desirable lower limit of about 46.5 pcs/cm² (about 300 cpsi), and a furthermore desirable lower limit of about 62 pcs/cm² (about 400 cpsi). On the other hand, the cell density has a desirable upper limit of about 186 pcs/cm² (about 1200 cpsi), a more desirable upper limit of about 170.5 pcs/cm² (about 110 cpsi), and a furthermore desirable upper limit of about 155 pcs/cm² (about 1000 cpsi).

When the cell density is about 15.5 pcs/cm² or more, an area of the cell wall contacting the exhaust gases within the honeycomb fired body does not tend to be reduced upon using the honeycomb structure as a catalyst supporting carrier for converting the exhaust gases, and when the cell density is about 186 pcs/cm² or less, pressure loss does not tend to become high and also manufacturing of the honeycomb fired body may become easier.

In addition, desirably, a cross-sectional area of the honeycomb fired body in the direction perpendicular to the longitudinal direction of the honeycomb fired body has a lower limit of about 5 cm² and an upper limit of about 50 cm², and particularly when the honeycomb structure is formed by binding a plurality of the honeycomb fired bodies together, the cross-sectional area is desirably within the above-mentioned range.

When the cross-sectional area is about 5 cm² or more, since an area of the sealing material layer (adhesive layer), with which a plurality of the honeycomb fired bodies are bound, is not relatively increased in a cross section perpendicular to the longitudinal direction of the honeycomb structure, an area on which a catalyst can be supported does not tend to be relatively reduced upon using the honeycomb structure as a catalyst supporting carrier. On the other hand, when the cross-sectional area is about 50 cm² or less, it may become easier to sufficiently suppress thermal stress generated in the honeycomb fired body since the honeycomb fired body does not become too large.

The cross-sectional area has a more desirable lower limit of about 6 cm², and a particularly desirable lower limit of about 8 cm², and a more desirable upper limit of about 40 cm², and a particularly desirable upper limit of about 30 cm².

A shape of a cross section perpendicular to the longitudinal direction of a cell formed in the honeycomb fired body is not particularly limited, and an approximate triangle or an approximate hexagon may be used other than a rectangle like the honeycomb fired body shown in FIG. 1(a).

Further, when the sealing material layer (adhesive layer) and the sealing material layer (coat layer) are formed in the honeycomb structure, desirably, a ratio of the total cross-sectional area of the honeycomb fired bodies to the cross-sectional area of the honeycomb structure is about 90% or more in a cross section perpendicular to the longitudinal direction of the honeycomb structure. The reason for this is that when this ratio is about 90% or more, the specific surface area of the honeycomb structure does not tend to be reduced.

In addition, desirably, the specific surface area per unit area of the honeycomb structure is about 25000 m²/L (litter) or more.

The reason for this is that when the specific surface area is within the above range, it becomes easy to sufficiently broadly support and disperse a catalyst on the whole honeycomb structure.

Incidentally, a desirable upper limit of the specific surface area is about 70000 m²/L in consideration of the limit of dispersion of the catalyst (for example, platinum).

It is more desirable that a bending strength of the honeycomb structure is higher, and specifically, it is desirable that the bending strength is about 3.0 MPa or more when the honeycomb fired body has a rectangular pillar shape of about 37 mm×about 37 mm×about 75 mm.

The reason for this is that a possibility of destruction of the honeycomb structure due to thermal stress and the like generated upon using the honeycomb structure becomes less.

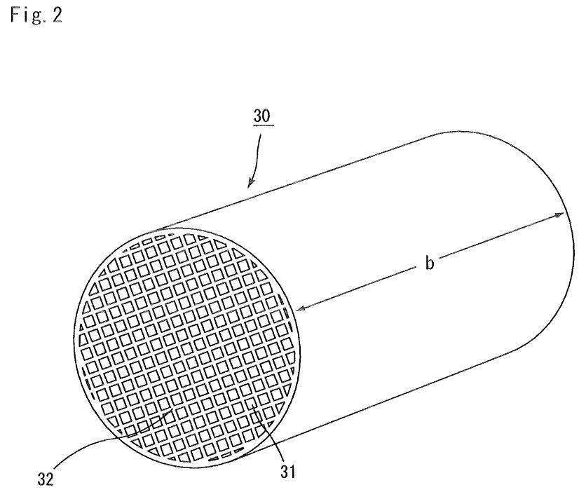

In addition, the honeycomb structure manufactured by the method for manufacturing a honeycomb structure according to the embodiment of the present invention is not limited to an aggregated honeycomb structure as shown in FIG. 1(b), and it may be an integral honeycomb structure as shown in FIG. 2.

FIG. 2 is a perspective view schematically showing another example of the honeycomb structure manufactured by the method for manufacturing a honeycomb structure according to the embodiment of the present invention.

A honeycomb structure 30 shown in FIG. 2 is formed by a honeycomb fired body having a pillar shape, and having a large number of cells 31 (in the direction shown by an arrow b in FIG. 2) disposed in substantially parallel with one another in a longitudinal direction with a cell wall 32 therebetween.

Further, in the integral honeycomb structure of this kind, a sealing material layer (coat layer) may be formed on the periphery of the honeycomb fired body.

In addition, a catalyst is desirably supported on the honeycomb structure having such a configuration. The reason for this is that the honeycomb structure can be suitably used as a catalyst supporting carrier.

The catalyst is not particularly limited, and examples of the catalyst include noble metals, alkali metals, alkaline earth metals, oxides and the like. These may be used alone or in combination of two or more kinds.

Examples of the noble metals include platinum, palladium, rhodium and the like, examples of the alkali metals include potassium, sodium and the like, examples of the alkaline earth metals include barium and the like, and examples of the oxides include perovskite (La_{0.75}K_{0.25}MnO₃ and the like), CeO₂ and the like.

The applications of the honeycomb structure on which a catalyst is supported as described above is not particularly limited, and the honeycomb structure can be used for, for example, the so-called three-way catalyst for converting the exhaust gases of automobiles or a NOx adsorbing catalyst.

Incidentally, a timing of supporting a catalyst is not particularly limited, and the catalyst may be supported after manufacturing the honeycomb structure, or may be supported on inorganic particles in the raw material composition.

Further, a method for supporting a catalyst is not particularly limited, and the catalyst can be supported, for example, by an impregnation method.

Here, the method for manufacturing a honeycomb structure according to the embodiment of the present invention and the honeycomb structure manufactured by this method has been described with examples mainly using the honeycomb structure as a catalyst supporting carrier, but the honeycomb structure can be used for other purposes besides a catalyst supporting carrier, and it can be used for adsorbents which adsorb gas components or liquid components, for example.

### EXAMPLES

Hereinafter, the present invention will be described in more detail by way of Examples, but the present invention is not limited to these Examples.

### Example 1

(1) 2250 g of γ alumina particles (secondary particles having an average particle diameter of 2 μm) as inorganic particles, 680 g of aluminum borate whiskers (fiber diameters are 0.5 to 1 μm, fiber lengths are 10 to 30 μm) as inorganic fibers, and 2600 g of silica sol (an average particle diameter is 15 nm, concentration is 35% by weight) as an inorganic binder solution were mixed, and further to the resulting mixture, 320 g of methyl cellulose as an organic binder, 290 g of UNILUB (manufactured by NOF Corp.) as a lubricant, and 225 g of glycerin (manufactured by NOF Corp.) as a plasticizer were added, and the resulting mixture was further mixed and kneaded to prepare a raw material composition. Next, this raw material composition was extrusion-molded with an extrusion-molding machine to manufacture a honeycomb molded body.

(2) Next, the honeycomb molded body was dried well with a microwave drying apparatus and a hot-air drying apparatus, and further kept at 400° C. for 2 hours to be degreased.

Thereafter, a firing treatment was carried out on the honeycomb molded body while keeping the honeycomb molded body at 900° C. for 2 hours to manufacture a honeycomb fired body having a rectangular pillar shape (37 mm×37 mm×75 mm), a cell density of 93 pcs/cm² (600 cpsi), a thickness of a cell wall of 0.2 mm, with a cross-sectional shape of cells formed into a rectangular (square) shape.

### Examples 2, 3

Honeycomb fired bodies were manufactured by following the same procedure as in Example 1 except for using silica sol (average particle diameter is 15 nm) having concentrations shown in Table 1-1 as an inorganic binder solution used upon preparing a raw material composition.

### Example 4

A honeycomb fired body was manufactured by following the same procedure as in Example 1 except for using alumina sol (average particle diameter is 15 nm, concentration is 35% by weight) in place of the silica sol upon preparing a raw material composition.

### Example 5

A honeycomb fired body was manufactured by following the same procedure as in Example 1 except for using mixed particles of 50% by weight of γ alumina particles (secondary particles having an average particle diameter of 2 μm) and 50% by weight of β zeolite particles (secondary particles having an average particle diameter of 2 μm) in place of the γ alumina particles as inorganic particles.

### Examples 6, 7

Honeycomb fired bodies were manufactured by following the same procedure as in Example 5 except for using silica sol (average particle diameter is 15 nm) having concentrations shown in Table 1-1 as an inorganic binder solution used upon preparing a raw material composition.

### Example 8

A honeycomb fired body was manufactured by following the same procedure as in Example 5 except for using alumina sol (average particle diameter is 15 nm, concentration is 35% by weight) in place of the silica sol upon preparing a raw material composition.

### Example 9

A honeycomb fired body was manufactured by following the same procedure as in Example 1 except for using mixed particles of 50% by weight of γ alumina particles (secondary particles having an average particle diameter of 2 μm) and 50% by weight of CeO₂ particles (secondary particles having an average particle diameter of 2 μm) in place of the secondary particles of the γ alumina particles as inorganic particles.

### Examples 10, 11

Honeycomb fired bodies were manufactured by following the same procedure as in Example 9 except for using silica sol (average particle diameter is 15 nm) having concentrations shown in Table 1-1 as an inorganic binder solution used upon preparing a raw material composition.

### Example 12

A honeycomb fired body was manufactured by following the same procedure as in Example 9 except for using alumina sol (average particle diameter is 15 nm, concentration is 35% by weight) in place of the silica sol upon preparing a raw material composition.

### Example 13

A honeycomb fired body was manufactured by following the same procedure as in Example 1 except for preparing a raw material composition by the following method.

That is, 2970 g of γ alumina particles (secondary particles having an average particle diameter of 2 μm) as inorganic particles, 900 g of aluminum borate whiskers (fiber diameter is 0.5 to 1 μm, fiber length is 10 to 30 μm) as inorganic fibers, and 1660 g of silica sol (average particle diameter is 15 nm, concentration is 35% by weight) as an inorganic binder solution were mixed, and further to the resulting mixture, 320 g of methyl cellulose as an organic binder, 290 g of UNILUB (manufactured by NOF Corp.) as a lubricant, and 225 g of glycerin (manufactured by NOF Corp.) as a plasticizer were added, and the resulting mixture was mixed and kneaded to prepare a raw material composition.

### Examples 14, 15

Honeycomb fired bodies were manufactured by following the same procedure as in Example 13 except for using silica sol (average particle diameter is 15 nm) having concentrations shown in Table 1-1 as an inorganic binder solution used upon preparing a raw material composition.

### Example 16

A honeycomb fired body was manufactured by following the same procedure as in Example 1 except for preparing a raw material composition by the following method.

That is, 1780 g of γ alumina particles (secondary particles having an average particle diameter of 2 μm) as an inorganic particles, 400 g of aluminum borate whiskers (fiber diameter is 0.5 to 1 μm, fiber length is 10 to 30 μm) as inorganic fibers, and 3300 g of silica sol (average particle diameter is 15 nm, concentration is 35% by weight) as an inorganic binder solution were mixed, and further to the resulting mixture, 320 g of methyl cellulose as an organic binder, 290 g of UNILUB (manufactured by NOF Corp.) as a lubricant, and 225 g of glycerin (manufactured by NOF Corp.) as a plasticizer were added, and the resulting mixture was mixed and kneaded to prepare a raw material composition.

### Examples 17, 18

Honeycomb fired bodies were manufactured by following the same procedure as in Example 16 except for using silica sol (average particle diameter is 15 nm) having concentrations shown in Table 1-1 as an inorganic binder solution used upon preparing a raw material composition.

### Comparative Examples 1, 2

Honeycomb fired bodies were manufactured by following the same procedure as in Example 1 except for using silica sol (average particle diameter is 15 nm) having concentrations shown in Table 1-2 as an inorganic binder solution used upon preparing a raw material composition.

### Comparative Example 3

A honeycomb fired body was manufactured by following the same procedure as in Example 4 except for using alumina sol (average particle diameter is 15 nm) having a concentration shown in Table 1-2 as an inorganic binder solution used upon preparing a raw material composition.

### Comparative Examples 4, 5

Honeycomb fired bodies were manufactured by following the same procedure as in Example 5 except for using silica sol (average particle diameters is 15 nm) having concentrations shown in Table 1-2 as an inorganic binder solution used upon preparing a raw material composition.

### Comparative Example 6

A honeycomb fired body was manufactured by following the same procedure as in Example 8 except for using alumina sol (average particle diameter is 15 nm) having a concentration shown in Table 1-2 as an inorganic binder solution used upon preparing a raw material composition.

### Comparative Examples 7, 8

Honeycomb fired bodies were manufactured by following the same procedure as in Example 9 except for using silica sol (average particle diameter is 15 nm) having concentrations shown in Table 1-2 as an inorganic binder solution used upon preparing a raw material composition.

### Comparative Example 9

A honeycomb fired body was manufactured by following the same procedure as in Example 12 except for using alumina sol (average particle diameter is 15 nm) having a concentration shown in Table 1-2 as an inorganic binder solution used upon preparing a raw material composition.

### Comparative Example 10

A honeycomb fired body was manufactured by following the same procedure as in Comparative Example 1 except for changing the amount of an inorganic binder solution (silica sol) used upon preparing a raw material composition to 2000 g.

Here, in Examples 1 to 18 and Comparative Examples 1 to 10, SNOWTEX 30, manufactured by Nissan Chemical Industries, Ltd., was used as the silica sol having a concentration of 30% by weight, and SNOWTEX 30s condensed to prescribed concentrations were used as the silica sols having the concentrations of 35% by weight, 40% by weight, 50% by weight and 60% by weight. In addition, ALUMINASOL 520s (alumina concentration is 20% by weight), manufactured by Nissan Chemical Industries, Ltd., condensed to prescribed concentrations were used as the alumina sols having the concentrations of 30% by weight and 35% by weight.

[Evaluation of Honeycomb Fired Bodies]

In the manufacture of the honeycomb fired bodies of Examples and Comparative Examples, the extrusion-molded honeycomb molded bodies were dried, and then on the dried honeycomb molded bodies, the presence or absence of the generation of cracks was evaluated. Furthermore, on the manufactured honeycomb fired bodies, their configurations (presence or absence of deformation) were evaluated.

The results are shown in Tables 1-1 and 1-2.

[Evaluation of Presence or Absence of Generation of Cracks]

The presence or absence of the generation of cracks was evaluated by visually observing the dried honeycomb molded bodies.

[Evaluation of Configurations of Honeycomb Fired Bodies]

The flatness of the side face of the manufactured honeycomb fired bodies was measured by the following method, and the honeycomb fired body in which the flatness of all side faces was 0.5 mm or less was rated as “+,” and the honeycomb fired body in which the flatness of any one side face was more than 0.5 mm was rated as “-.’

Here, the flatness of the honeycomb fired bodies was evaluated by plotting a position coordinate of the side face of the honeycomb fired bodies by a coordinate measuring machine (BH-V507, manufactured by Mitutoyo Corp.).

TABLE 1-1

| | | | | Blending | | |
|---|---|---|---|---|---|---|
| | | | Concentration | amount of | | |
| | | | of inorganic | inorganic | Presence or | |
| | Inorganic | Inorganic | binder *(note) | binder | absence | Evaluation of |
| | particles | binder | (% by weight) | (% by weight) | of cracks | configuration |
| Example 1 | γ alumina | silica sol | 35 | 47 | none | + |
| Example 2 | γ alumina | silica sol | 40 | 47 | none | + |
| Example 3 | γ alumina | silica sol | 50 | 47 | none | + |
| Example 4 | γ alumina | alumina sol | 35 | 47 | none | + |
| Example 5 | γ alumina + | silica sol | 35 | 47 | none | + |
| | β zeolite | | | | | |
| Example 6 | γ alumina + | silica sol | 40 | 47 | none | + |
| | β zeolite | | | | | |
| Example 7 | γ alumina + | silica sol | 50 | 47 | none | + |
| | β zeolite | | | | | |
| Example 8 | γ alumina + | alumina sol | 35 | 47 | none | + |
| | β zeolite | | | | | |
| Example 9 | γ alumina + | silica sol | 35 | 47 | none | + |
| | CeO₂ | | | | | |
| Example 10 | γ alumina + | silica sol | 40 | 47 | none | + |
| | CeO₂ | | | | | |
| Example 11 | γ alumina + | silica sol | 50 | 47 | none | + |
| | CeO₂ | | | | | |
| Example 12 | γ alumina + | alumina sol | 35 | 47 | none | + |
| | CeO₂ | | | | | |
| Example 13 | γ alumina | silica sol | 35 | 30 | none | + |
| Example 14 | γ alumina | silica sol | 40 | 30 | none | + |
| Example 15 | γ alumina | silica sol | 50 | 30 | none | + |
| Example 16 | γ alumina | silica sol | 35 | 60 | none | + |
| Example 17 | γ alumina | silica sol | 40 | 60 | none | + |
| Example 18 | γ alumina | silica sol | 50 | 60 | none | + |

*(note)
Blending amount of inorganic binder: Blending amount of inorganic binder solution to total amount of inorganic particles, inorganic whiskers, and inorganic binder

TABLE 1-2

| | | | | Blending | | |
|---|---|---|---|---|---|---|
| | | | Concentration | amount of | | |
| | | | of inorganic | inorganic | Presence or | |
| | Inorganic | Inorganic | binder *(note) | binder | absence | Evaluation of |
| | particles | binder | (% by weight) | (% by weight) | of cracks | configuration |
| Comparative | γ alumina | silica sol | 30 | 47 | present | + |
| Example 1 | | | | | | |
| Comparative | γ alumina | silica sol | 60 | 47 | none | − |
| Example 2 | | | | | | |
| Comparative | γ alumina | alumina sol | 30 | 47 | present | + |
| Example 3 | | | | | | |
| Comparative | γ alumina + | silica sol | 30 | 47 | present | + |
| Example 4 | β zeolite | | | | | |
| Comparative | γ alumina + | silica sol | 60 | 47 | none | − |
| Example 5 | β zeolite | | | | | |
| Comparative | γ alumina + | alumina sol | 30 | 47 | present | + |
| Example 6 | β zeolite | | | | | |
| Comparative | γ alumina + | silica sol | 30 | 47 | present | + |
| Example 7 | CeO₂ | | | | | |
| Comparative | γ alumina + | silica sol | 60 | 47 | none | − |
| Example 8 | CeO₂ | | | | | |
| Comparative | γ alumina + | alumina sol | 30 | 47 | present | + |
| Example 9 | CeO2 | | | | | |
| Comparative | γ alumina | silica sol | 30 | 41 | none | − |
| Example 10 | | | | | | |

*(note)
Blending amount of inorganic binder: Blending amount of inorganic binder solution to total amount of inorganic particles, inorganic whiskers, and inorganic binder

As is apparent from the results shown in Tables 1-1 and 1-2, by using the inorganic binder solution having a concentration of about 35 to about 50% by weight with a blending amount of about 30 to about 60% by weight, it is possible to manufacture a honeycomb fired body having a desired configuration, which does not generate cracks and does not cause deformations upon drying the honeycomb molded body.

On the other hand, when the concentration of the inorganic binder solution was less than about 35% by weight, the cracks were observed upon drying the honeycomb molded body, although the deformation in the configuration of the honeycomb fired body was not observed. In addition, when the concentration of the inorganic binder solution is more than about 50% by weight, cracks were not observed in the dried honeycomb molded body, but the manufactured honeycomb fired body was deformed.

In addition, in Examples and Comparative Examples described above, one honeycomb fired body was manufactured and this honeycomb fired body was evaluated as a honeycomb structure, but in the case where an aggregated honeycomb structure as shown in FIGS. 1(a) and 1(b) is manufactured by using a plurality of the honeycomb fired bodies, similar results are presumably obtained.

Obviously, numerous modifications and variations of the present invention are possible in light of the above teachings. It is therefore to be understood that within the scope of the appended claims, the invention may be practiced otherwise than as specifically described herein.

1. A method for manufacturing a honeycomb structure, comprising:
mixing inorganic particles, at least one of inorganic fibers and inorganic whiskers, and an inorganic binder solution to prepare a raw material composition;
manufacturing a pillar-shaped honeycomb molded body having a large number of cells disposed in substantially parallel with one another in a longitudinal direction with a cell wall therebetween by extrusion-molding said raw material composition; and
carrying out a firing treatment on said honeycomb molded body to manufacture a honeycomb fired body,
wherein a blending amount of said inorganic binder solution is about 30 to about 60% by weight to a total amount of said inorganic particles, at least one of inorganic fibers and inorganic whiskers, and said inorganic binder solution, and
a concentration of said inorganic binder solution is about 35 to about 50% by weight.

2. The method for manufacturing a honeycomb structure according to claim 1,
wherein said inorganic binder solution is at least one kind selected from the group consisting of alumina sol, silica sol, titania sol, a suspension of sepiolite and a suspension of attapulgite.

3. The method for manufacturing a honeycomb structure according to claim 1,
wherein an average particle diameter of an inorganic binder in the inorganic binder solution is about 10 nm to about 50 nm.

4. The method for manufacturing a honeycomb structure according to claim 1,
wherein the inorganic particles comprise at least one of alumina, silica, zirconia, titania, ceria, mullite, and zeolite.

5. The method for manufacturing a honeycomb structure according to claim 1,
wherein a blending amount of the inorganic particles in the raw material composition is about 30% to about 85% by weight with respect to a total solid content of the inorganic particles, at least one of the inorganic fibers and the inorganic whiskers, and the inorganic binder.

6. The method for manufacturing a honeycomb structure according to claim 1,
wherein at least one of the inorganic fibers and the inorganic whiskers comprise at least one of alumina, silica, silicon carbide, silica-alumina, glass, potassium titanate, and aluminum borate.

7. The method for manufacturing a honeycomb structure according to claim 1,
wherein an average aspect ratio of at least one of the inorganic fibers and the inorganic whiskers is about 10 to about 1000.

8. The method for manufacturing a honeycomb structure according to claim 1,
wherein a blending amount of at least one of the inorganic fibers and the inorganic whiskers in the raw material composition is about 3% to about 50% by weight with respect to a total solid content of the inorganic particles, at least one of the inorganic fibers and the inorganic whiskers, and the inorganic binder.

9. The method for manufacturing a honeycomb structure according to claim 1,
wherein a firing temperature in the firing treatment is about 500° C. to about 1200° C.

10. The method for manufacturing a honeycomb structure according to claim 1, further comprising:
providing a coat layer on the periphery of the honeycomb fired body.

11. The method for manufacturing a honeycomb structure according to claim 1,
wherein the honeycomb structure is formed of a single honeycomb fired body.

12. The method for manufacturing a honeycomb structure according to claim 1, further comprising:
binding a plurality of the honeycomb fired bodies together to form the honeycomb structure.

13. The method for manufacturing a honeycomb structure according to claim 12,
wherein a cross-sectional area of the honeycomb fired body in a direction perpendicular to a longitudinal direction of the honeycomb fired body is about 5 cm² to about 50 cm².

14. The method for manufacturing a honeycomb structure according to claim 1, further comprising:
providing at least one of an adhesive layer and a coat layer on the honeycomb fired body,
wherein a ratio of a cross-sectional area of the honeycomb fired body in a plane perpendicular to a longitudinal direction of the honeycomb structure to a cross-sectional area of the honeycomb structure in the plane is at least about 90%.

15. The method for manufacturing a honeycomb structure according to claim 1,
wherein a specific surface area per unit area of the honeycomb structure is about 25000 m²/L to about 70000 m²/L.

16. The method for manufacturing a honeycomb structure according to claim 1, further comprising:
supporting a catalyst on the honeycomb fired body.

17. The method for manufacturing a honeycomb structure according to claim 16,
wherein the catalyst comprises at least one of noble metals, alkali metals, alkaline earth metals, and oxides.
